(19) United States
(12) Patent Application Publication
(10) Pub. No.: US 2012/0200573 A1
(43) Pub. Date: Aug. 9, 2012

(54) E-READER WITH LOCKED AND UNLOCKED CONTENT AND READER TRACKING CAPABILITY

(75) Inventors: Ryan Stoner, Los Angeles, CA (US); Oliver Rabenschlag, Los Angeless, CA (US); Drew McAuliffe, Los Angeles, CA (US)

(73) Assignee: Hooray LLC

(21) Appl. No.: 13/022,594

(22) Filed: Feb. 7, 2011

(51) Int. Cl. G06T 11/00

(52) U.S. Cl. 345/472

(57) ABSTRACT

A system and method for enhancing the reading experience of an e-book is disclosed. The system comprises an application program configured for installation to an electronic device, a plurality of markup tags to display information stored in the e-book, the system adaptable to create at least one page of the e-book dynamically and to compile the at least one page at run-time. The plurality of markup tags indicates a triggering event or for the system to unlock information stored in the e-book. The processing engine records the progress of a user through the e-book and the user's interactions with the plurality of markup tags. The system and method enable a publisher to quickly, easily, and inexpensively enhance a user's experience of an e-book. The process of adding markup tags to an existing e-book allows a publisher to add additional content and interactive features to an e-book without expensive and time consuming processes, and without reformatting the entire e-book.

### RELATED APPLICATIONS

This application is related to two U.S. patent applications filed on an even date herewith: “IMPROVED E-READER WITH DYNAMIC CONTENT AND READER TRACKING CAPABILITY” filed as a U.S. application Ser. No. ______ (Attorney Docket No. 370.02) and “IMPROVED E-READER WITH DYNAMIC CONTENT AND READER TRACKING CAPABILITY” filed as a U.S. application Ser. No. ______ (Attorney Docket No. 370.03).

### BACKGROUND OF THE INVENTION

1. Technical Field of the Invention

This invention relates in general to systems for enhancing the reading experience of an e-book, and more specifically, to a system adaptable to create and add multiple layers of content dynamically to an existing e-book and to track a user's progress through the e-book for the purposes of enhancing the user's reading experience.

2. Description of the Related Art

The popularity of electronic books (e-books) has increased tremendously in recent years. E-Books are usually read on devices such as an iPad available through Apple Inc. of Cupertino, Calif. or a Kindle available through Amazon.com Inc. of Seattle, Wash. These and other devices use software generally referred to as an e-reader to interpret the e-books and display content for the user. E-books are published in a number of formats such as plain text (.txt), the Open Standard ePub (.epub), Amazon's Kindle format (.azw) and Portable Document Format (.pdf). Some devices display the e-book in hypertext web pages format (.html).

Book publishers have continuously explored ways to enhance the user's experience with the e-book by offering advantages that are not available in the print version of the original book. One common way to enhance the reading experience is to publish “interactive e-books”. Interactive e-books combine traditional book content, that is, written words and static pictures, with visual or aural effects only available electronically.

There are generally two methods employed for making e-Books interactive. The first method is to use static animated pages while the second method embeds interactive elements. Many animated e-Books currently use the first method. Here, the publisher using text, animations and/or aural effects creates each page of a story in the e-book independently. The pages are static, that is, each page of the e-Book looks the same for every user every time. However, creating an animated static e-Book page is time-consuming. It may be feasible for a children's story that has few words, but it is not desirable for a longer story because of the time it takes to create each page.

Another drawback of the static animated e-books is that because the pages of the animated e-books are static, the user cannot change the font size. This is because a change in the font size could make the page longer than what would fit on a single screen. Providing an option for the user to scroll through a screen too large to fit on one page of e-book display would be an option, however, current e-readers are not capable of this function. Unlike web pages, e-book pages have a fixed width and height. Therefore, changing the font size in the e-book necessarily requires an alteration to the number of pages. In a static animated e-book, this presents a problem because it would require the design of additional animated pages in order to make every page animated. Further, creating static animated pages for every possible font size is time consuming, so the publishers of animated books present the words in one, nonadjustable, font size. In this respect, the animated e-books are more like a series of static images, rather than an actual e-book.

To accomplish the second method, the pages of e-books are embedded with interactive content. Embedding interactive content is accomplished by adding markup languages like HTML or CSS to the text of the e-book. The e-reader reads markup tags in the e-books and displays an embedded video, sound, or flash animation within the text of the e-book. This method looks and performs just like a web page with embedded video, such as youtube.com, with text surrounding a video that will play when the user clicks or touches the play button. This type of embedded video is separate from the text of the story. That is, the animation cannot interact with the text of the e-book.

Some e-books use one of the two methods described above to add a layer of interactivity that requests the user to perform a task. For example, Penguin publishing has released a children's book in which tasks appear on each page. On one page, the reader can tidy up the character's room by dragging the toys and clothes to the character's dresser. This is done using the static animated page method of making an interactive e-book. Another limitation of the static animated page method of creating an interactive e-book is the fact that the pages are inherently static with respect to one another. As a consequence, an interaction or task performed on one page of the e-book does not alter the subsequent pages in the e-book.

Furthermore, performing a task or interaction on a page of an animated e-book does not make additional content available to the user. There is no backend program that keeps track of what tasks or interactions the user has performed in the currently available e-readers. Thus, the pages remain unchanged by the user's interaction.

One previous system, described in U.S. Pat. No. 7,631,013 issued to Parsons on Dec. 8, 2009 describes a book represented as a set of objects in a relational database schema format called IBF (Interactive Book Format) and the controlling system software. This design provides for viewing books in a manner that coordinates additional information and provides interaction with the original book, while not disturbing the original publication and copyrighted material and even protecting that copyrighted material from piracy by supporting industry standard digital rights management security features. The technique disclosed includes the use of conversion engines, which will aid publishers in converting existing books into IBF format. However, this system has no markup tags to track a user's progress through the e-reader.

Another previous solution is described in U.S. Pat. No. 7,748,634 issued to Zehr on Jul. 6, 2010 describes a handheld electronic book reader device equipped with dual displays. The device includes a first display for presenting visible representations of textual or graphic content related to the electronic book. The device also includes a second display positioned alongside the first display. The second display includes a plurality of graphic elements that correspond to portions of the first display. However, pages of this electronic book reader device do not have interactive elements and hence animations, videos and music cannot be embedded. Further, the e-reader does not record progress of a user through the e-book.

In contrast to the static realm of the e-books, video game content is very dynamic. In a video game, feats and achievements performed by the user are often tracked throughout the game by the game console. When the user satisfies certain requirements (collecting enough money, slaying a certain number of opposing players, etc.) the user is given access to more content (new parts of the virtual world or new characters are made accessible). In this way, the user's achievements in the video game are used to trigger the availability of previously unavailable media or content. Similarly, some content in the video game is only made available if the user performs a certain task in order to “unlock” the content.

For example, WIPO patent application No. WO/2010/105088 (attached) published to Jamie Vann describes a wagering game system and its operations. In certain embodiments, the operations can include tracking progress of a wagering game player account for a persistent-state game. The player account can fulfill progression requirements for the persistent-state game, such as by performing wagering game activities. Operations can mark the progress by presenting progress markers on a progress chart available to the player account. The progress chart can be based on an episodic theme. Even so, this system is not dynamic and no interactive elements are embedded.

Hence, it can be seen, that there is a need for a system for adding tasks and animations within the e-book that interact with the text and enhance the user's reading experience. Further, the needed device would include markup tags to track the user's progress through the e-book.

### SUMMARY OF THE INVENTION

To minimize the limitations found in the prior art, and to minimize other limitations that will be apparent upon the reading of the specification, the present invention provides a system for enhancing the reading experience of an e-book. The system comprises an application program configured to be installed in an electronic device, a plurality of markup tags to display information stored in the e-book and a processing engine adaptable to read the plurality of markup tags. The system is adaptable to create at least one page of the e-book dynamically and the plurality of markup tags is adaptable to indicate the existence of a triggering event such as an animation, ancillary content, a video, a website and an audio effect. The at least one page may created new or adapted from an existing e-book. The plurality of markup tags indicates when certain content stored in the e-book shall be unlocked. The unlocked content may be immediately available to the user or may be triggered to appear at a later point in the book. The processing engine records the progress of a user through the e-book and the plurality of markup tags reached by the user. The processing engine may further record whether certain ancillary content (whether initially locked or not) is viewed by the user. The system is adaptable to compile the at least one page at run-time.

In another aspect of the present invention, a method in accordance with the invention is described for enhancing the reading experience of the e-book. In this method, the application program is installed on the electronic device. The user launches the application program in the electronic device and a screen displaying a main menu for selecting the at least one feature and the at least one reading mode may be displayed. The at least one page is compiled at run-time and the processing engine reads the plurality of markup tags to display the information stored in the e-book.

One objective of the invention is to provide a system adaptable to include animations, tasks, ancillary content, videos, websites and audio effects in the e-book without creating static pages.

A second objective of the invention is to provide a plurality of markup tags for use by a processing engine to unlock some of the information stored in the e-book.

A third objective of the invention is to provide a processing engine to record progress of a user through the e-book and the plurality of markup tags interacted with by the user.

A fourth objective of the present invention is to provide a system and method to create at least one page of an e-book dynamically at run time.

These and other advantages and features of the present invention are described with specificity so as to make the present invention understandable to one of ordinary skill in the art.

### BRIEF DESCRIPTION OF THE DRAWINGS

In order to enhance their clarity and improve understanding of the various elements and embodiments of the invention, these elements in the figures have not necessarily been drawn to scale. Furthermore, in order to provide a clear view of the various embodiments of the invention, elements that are known to be common and well understood to those in the industry are not depicted. The foregoing aspects and many of the attendant advantages of the invention will become more readily appreciated and better understood by referencing the following detailed description, when taken in conjunction with the accompanying drawings, wherein:

FIG. 1 is a functional block diagram of a system for enhancing the reading experience of an e-book;

FIG. 2 is a diagrammatic representation of a main menu of the system according to an alternative embodiment of the invention;

FIG. 3 is a diagrammatic representation of selecting at least one reading mode from the main menu according to the alternative embodiment of the invention;

FIG. 4 is a diagrammatic representation of selecting the extras option from the main menu;

FIG. 5 is a diagrammatic representation of selecting settings feature from the main menu;

FIG. 6 is a diagrammatic representation for utilizing the at least one reading mode by a user;

FIG. 7 is a diagrammatic representation of a navigation bar of a reading mode 1;

FIG. 8 is a diagrammatic representation of a navigation bar of a reading mode 2; and

FIG. 9 is a diagrammatic representation of a navigation bar of a reading mode 3;

FIG. 10 is a an example of Content 1;

FIG. 11 is a first example of Content 2;

FIG. 12 is a second example of Content 2; and

FIG. 13 is diagrammatic representation of the steps of the system of a preferred embodiment.

### DETAILED DESCRIPTION OF THE DRAWINGS

In the following discussion that addresses a number of embodiments and applications of the present invention, reference is made to the accompanying drawings that form a part hereof, and in which is shown by way of illustration specific embodiments in which the invention may be practiced. It is to be understood that other embodiments may be utilized and changes may be made without departing from the scope of the present invention.

Various inventive features are described below that can each be used independently of one another or in combination with other features. However, any single inventive feature may not address any of the problems discussed above or only address one of the problems discussed above. Further, one or more of the problems discussed above may not be fully addressed by any of the features described below.

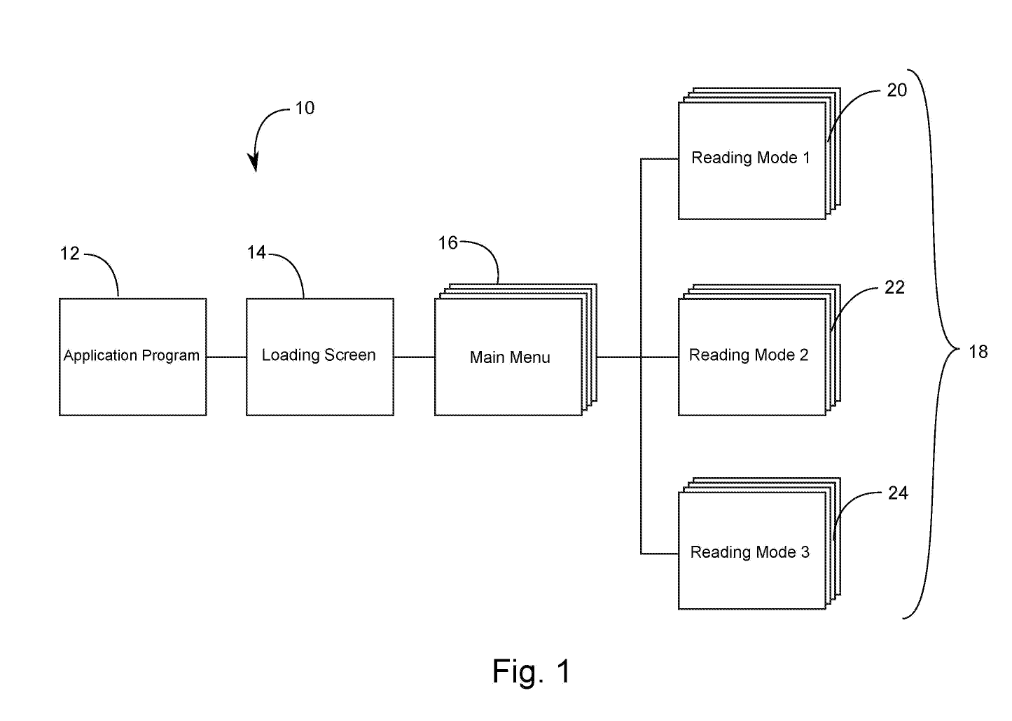

FIG. 1 is a functional block diagram of a system 10 for enhancing the reading experience of an e-book. The system 10 comprises an application program 12 configured for installation in an electronic device, a plurality of markup tags to display information stored in the e-book, a screen 14 optionally capable to display a cover page of the e-book and responsive to inputs by a user, a main menu 16 that may be used for selecting both at least one reading mode 18 (three exemplary reading modes are shown bracketed by reference number 18) and at least one feature (not shown) of the e-book, and a processing engine adaptable to read the plurality of markup tags. In alternative embodiments the processing engine is or is a part of the application program. The system 10 is adaptable to create at least one page of the e-book dynamically.

The e-book according to the preferred embodiment contains information, some of which is locked information, that is, not initially (or ever) available to the user. The plurality of markup tags indicates to the system to unlock some of said locked information stored in the e-book. The processing engine records data regarding the progress of a user through the e-book and the plurality of markup tags reached by the user. The system 10 compiles the at least one page at run-time, utilizing the data recorded in the process. The plurality of markup tags is adaptable to indicate existence of a triggering event such as an animation, ancillary content, video, a link to a website and/or audio effects. The system is adaptable to include such triggering events without necessarily requiring the use of static pages, as is commonplace to other e-books with similar effects. The electronic device may in a preferred embodiment be an e-reader capable of obtaining touch data from a user in response to touch events by the user on a screen, and in a more preferred embodiment selected from a group consisting of a mobile phone, an iPhone, iPad, and an Android device. The at least one reading mode 18 of the e-reader in exemplary embodiment is chosen from one of a reading mode 1 20, a reading mode 2 22 and a reading mode 3 24.

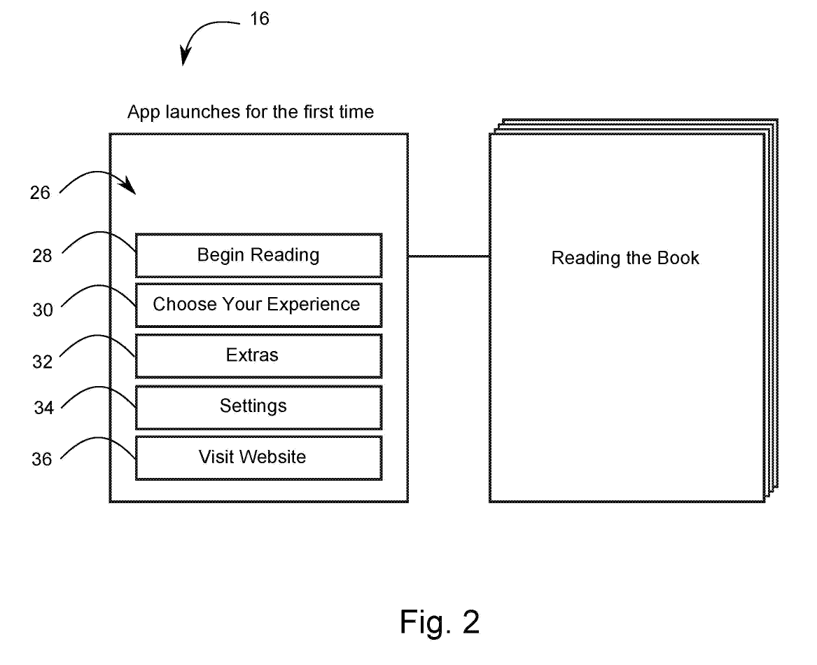

FIG. 2 is a diagrammatic representation of a main menu 16. The main menu 16 displays the at least one feature 26 such as but not limited those shown in this example, including “begin reading” 28, “choose your experience” 30, “extras” 32, “settings” 34 and a website link 36. If the user launches the application program 12 after having selected the at least one reading mode 18, the application program 12 may start in that mode automatically. The begin reading 28 option allows the user to begin reading the e-book.

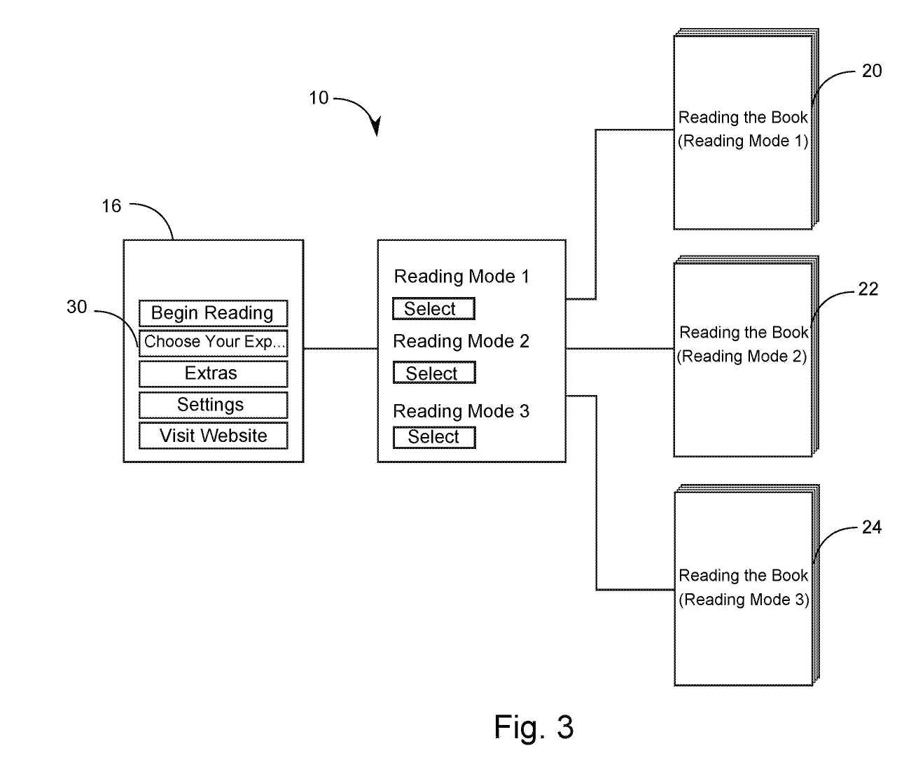

As shown in FIG. 3, the at least one reading mode 18 of the e-reader may be chosen by selecting “Choose your experience” 30 from the main menu 16. The user may read the e-book in any one of the at least one reading mode 18. The reading mode 1 20 provides a white background to the e-book. The reading mode 2 22 in an exemplary embodiment provides videos, animations, music and sound effects. The reading mode 3 24 provides in the exemplary embodiment videos, animations, page effects, music and dashboards items.

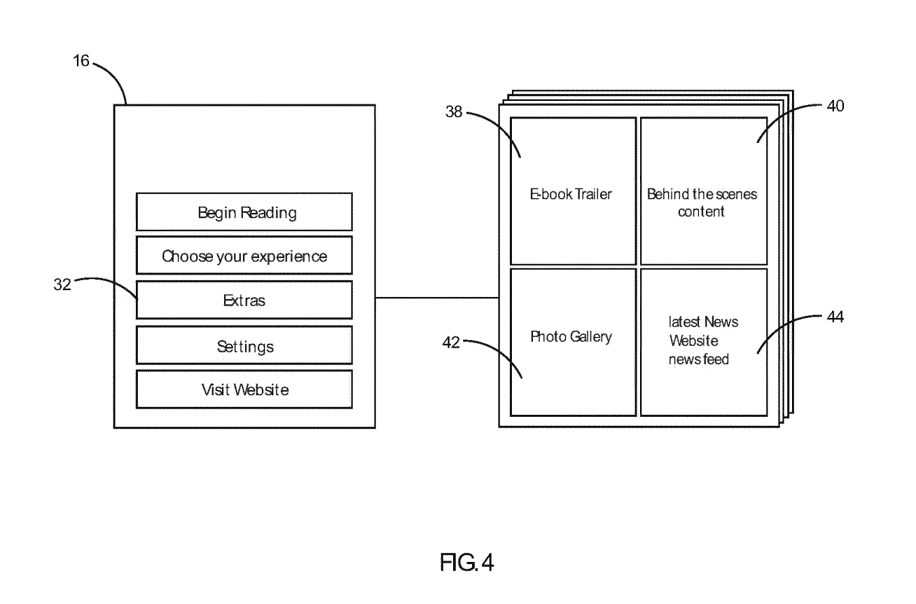

FIG. 4 shows the selection of the extras option 32 from the main menu 16. The extras option 32 in this case enables additional content such as trailer 38, behind the scenes 40, photo gallery 42 and latest news 44.

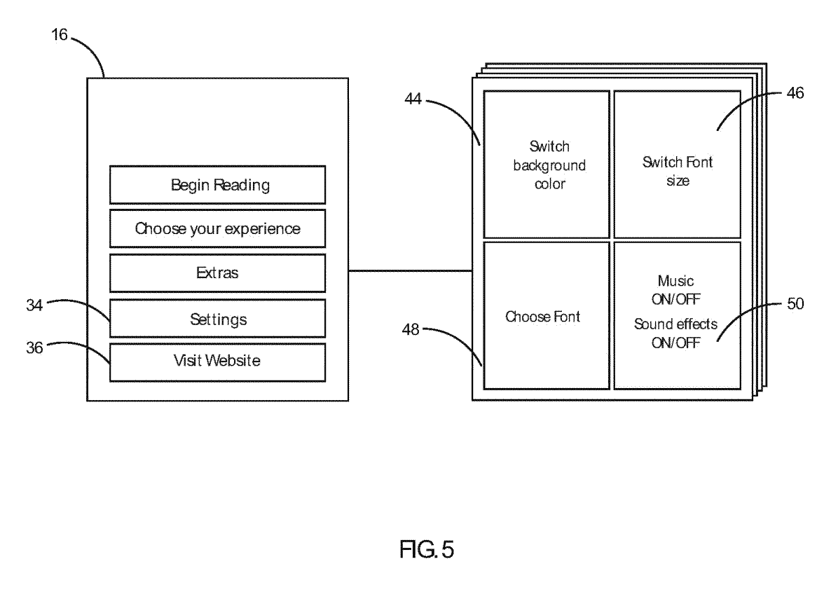

FIG. 5 shows the selection of the settings feature 34 from the main menu 16. The settings feature 34 may control system settings such as but not limited to settings such as switch background color 44, switch font size 46, choose font 48, and turning Music and Sound effects ON/OFF 50. The device directs the user to a website when the user clicks “Visit Website” 36 from the main menu 16.

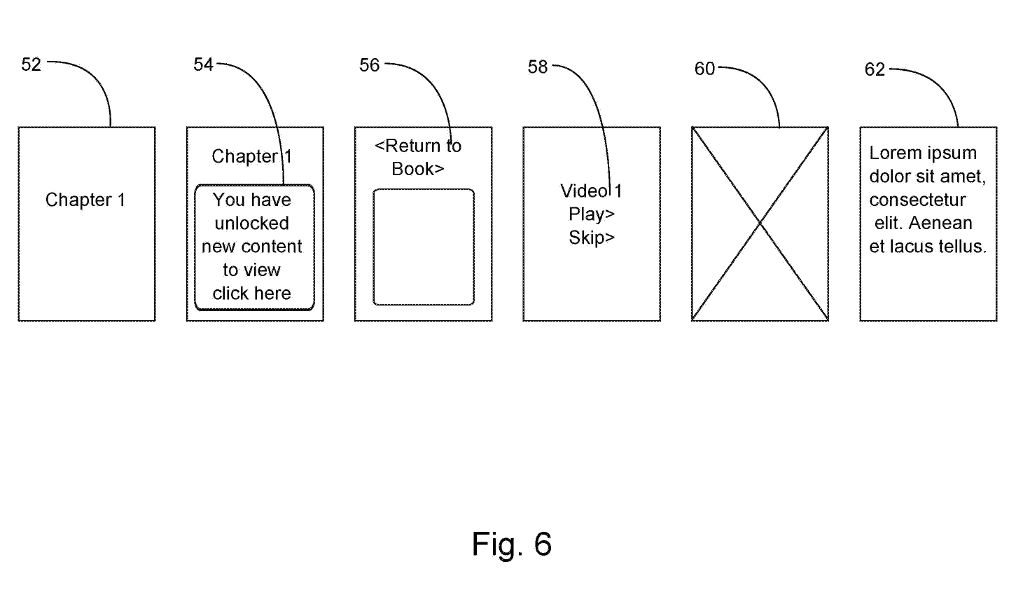

FIG. 6 is a schematic diagram illustrating an example for utilizing the at least one reading mode 18. A front page 52 of an e-book is displayed. In this example, a view of a scene is placed beneath the text, as representative of what will become one animation. When the reader begins the book new, the view of the scene is obscured from the reader because it falls into the category of aforementioned locked information. However, after being unlocked by a triggering event (such as the reader reaching a certain page or markup tag of the novel), it may become animated. In this example, when the view of the scene is unlocked, a pop up window 54 “You have unlocked new content To view, click here.” is displayed. When the user clicks on the pop up window 54, the user prompts and then experiences the animation. The next frame in FIG. 6 shows a link “Return to book” 56 that is displayed after the animation is complete. Here the user may return back to the e-book. Another example that may occur is shown in the fourth frame wherein the user is presented a “play” button 58, which, when clicked begins a video, shown as page 60. When the video is over, the user may be taken straight into a chapter 62 of the e-book.

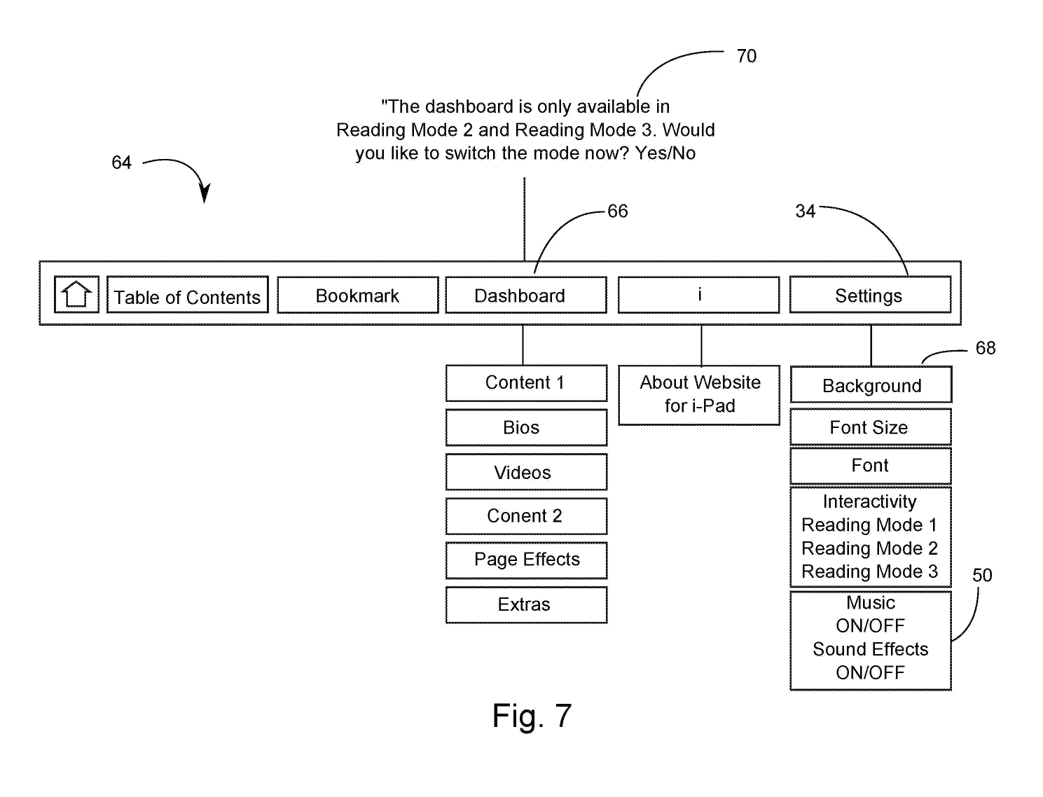

FIG. 7 shows a schematic diagram illustrating a navigation bar of the reading mode 1 64. For the reading mode 1 20, a dashboard icon 66 is deactivated. Upon the user touching the dashboard icon 66 a reading mode 1 popup window 70 may appear and in this exemplary case confirm to the user that: “The dashboard is only available in reading mode 2 and reading mode 3. Would you like to switch the mode now? Yes/No” is displayed. The dashboard icon 66 may include several features such as content 1, bios, videos, content 2, page effects and extras. Similarly, in the settings tab 34, Background 68 and Music and Sound effects 50 are activated/deactivated. Upon the user touching either of these options, a message similar to message 70 may appear.

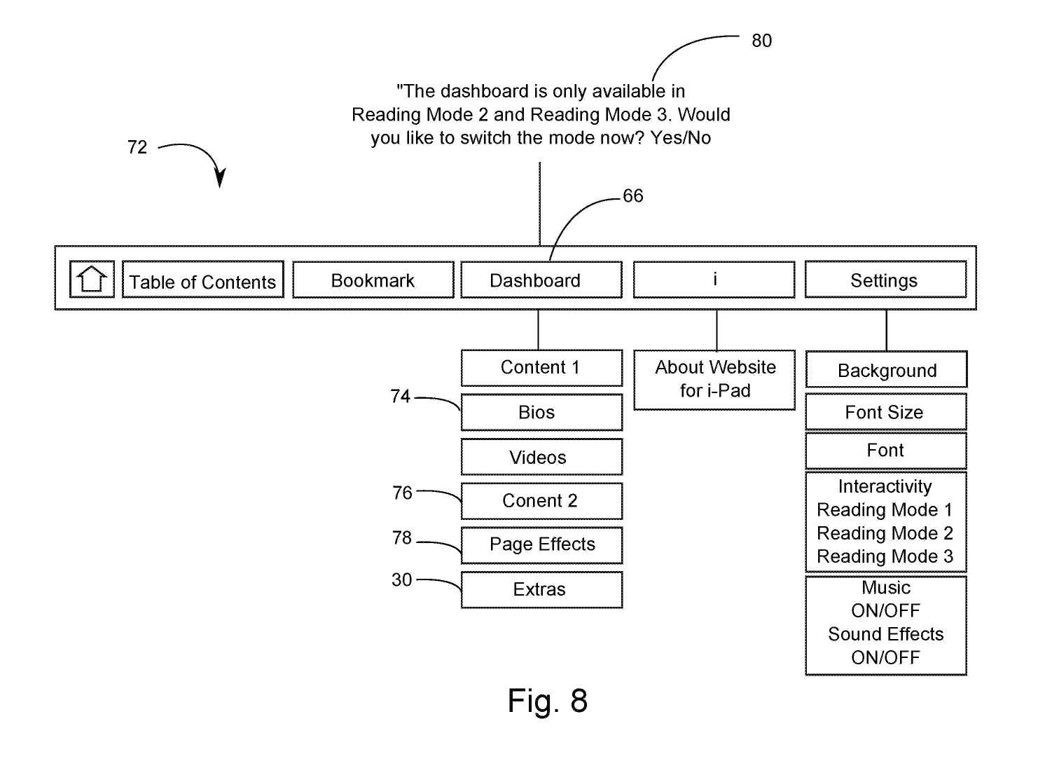

FIG. 8 shows a schematic diagram illustrating an exemplary navigation bar of a reading mode 2 72. For the reading mode 2 22, Bios 74, Content 2 76, page Effects 78 and Extras 30 are deactivated. Similar as detailed above with respect to FIG. 7, upon the user touching deactivated items a popup window may appear and ask the user whether the user would like to switch to reading mode 3.

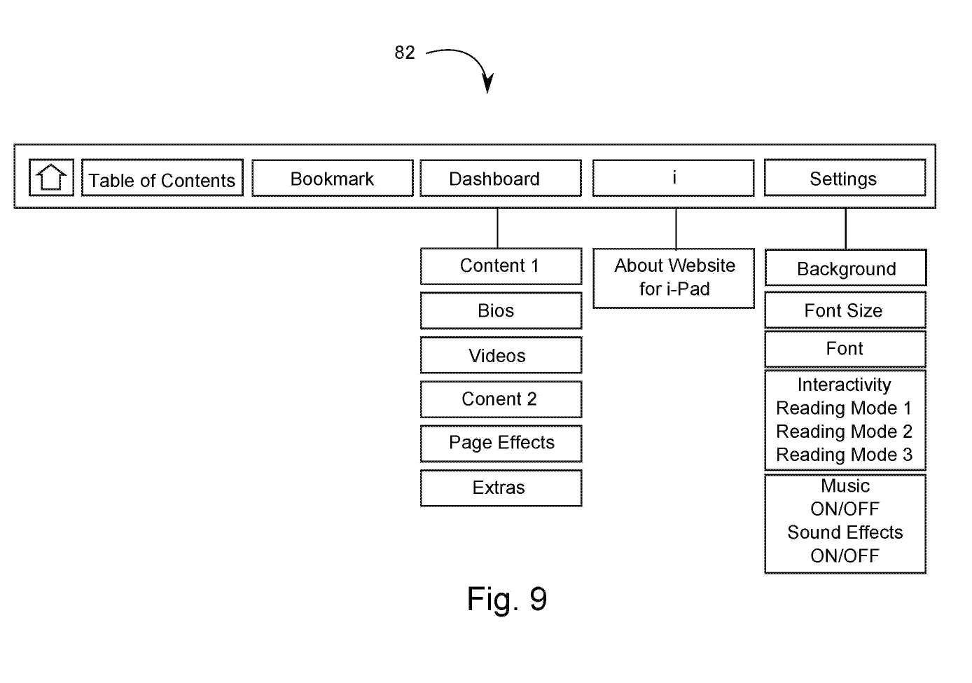

FIG. 9 shows a schematic diagram illustrating a navigation bar of reading mode 3 82. For reading mode 3 24, all features are active.

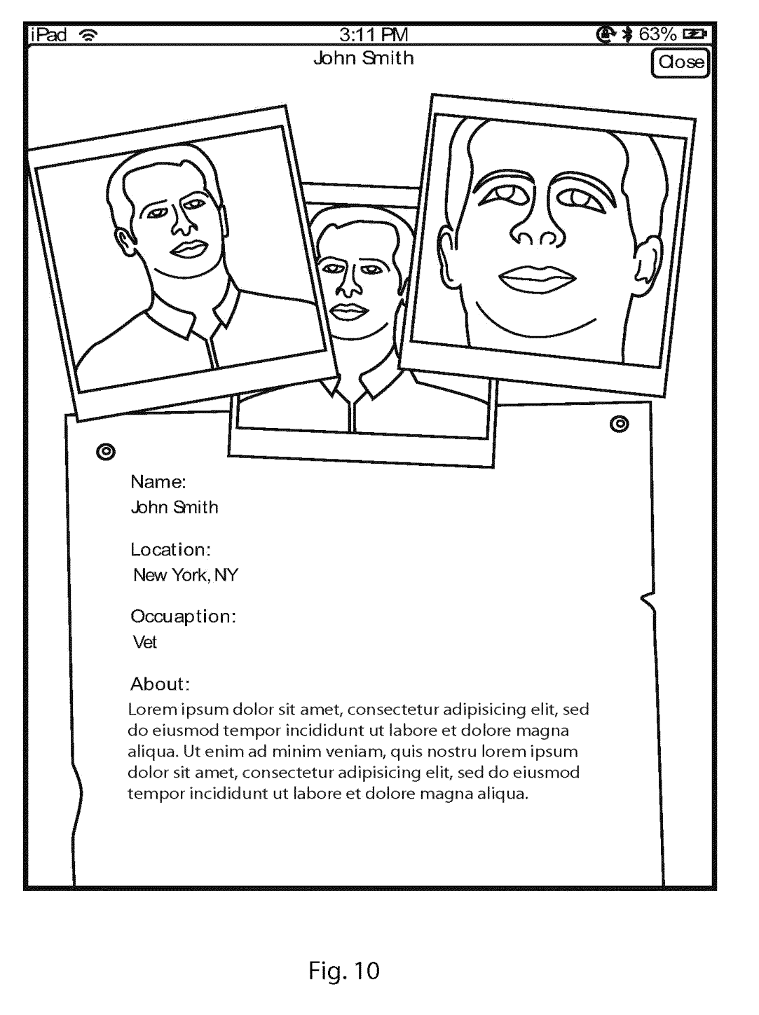

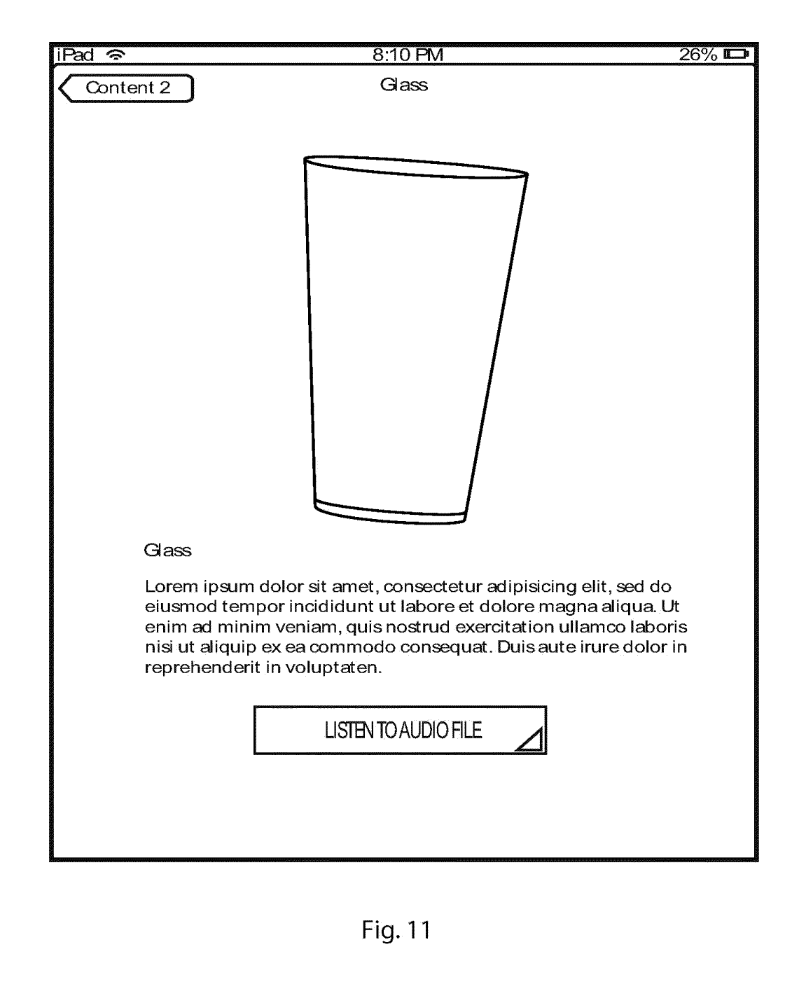

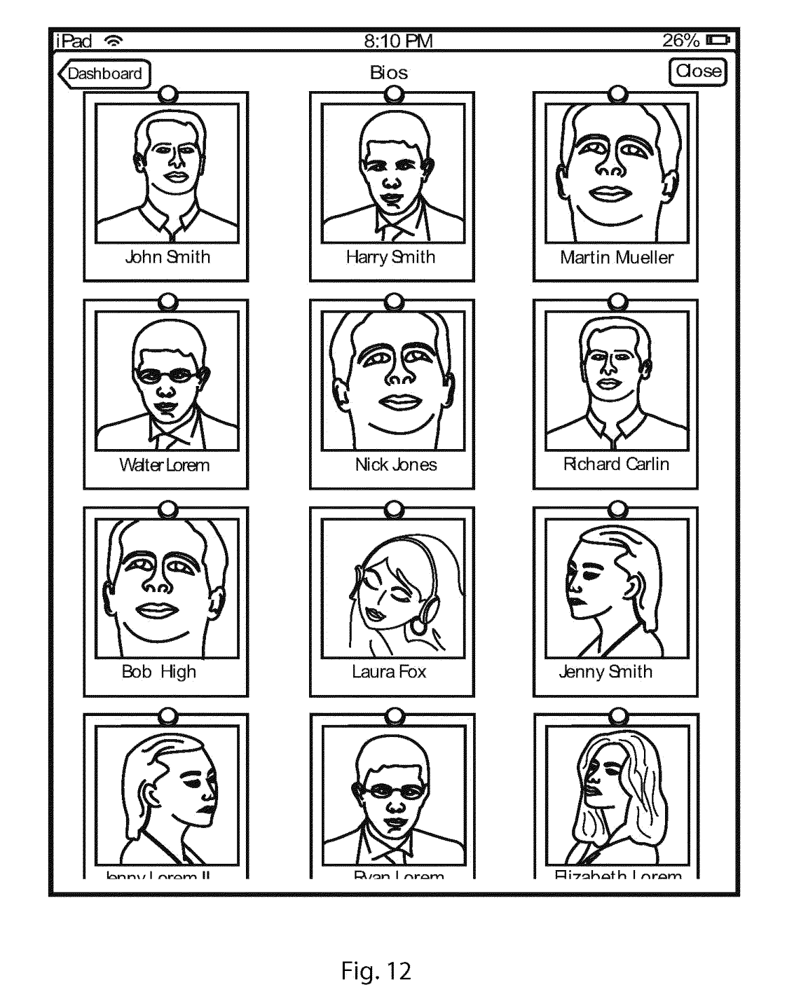

FIG. 10 shows an example of possible Content 1, in this embodiment being a biography of a character. FIG. 11 shows an example of possible content 2, in this embodiment being a piece of evidence. FIG. 12 shows an example of possible Bios, in this case being a collection of bios. Other types of information may be available as well, such as maps, timelines, clues, etc.

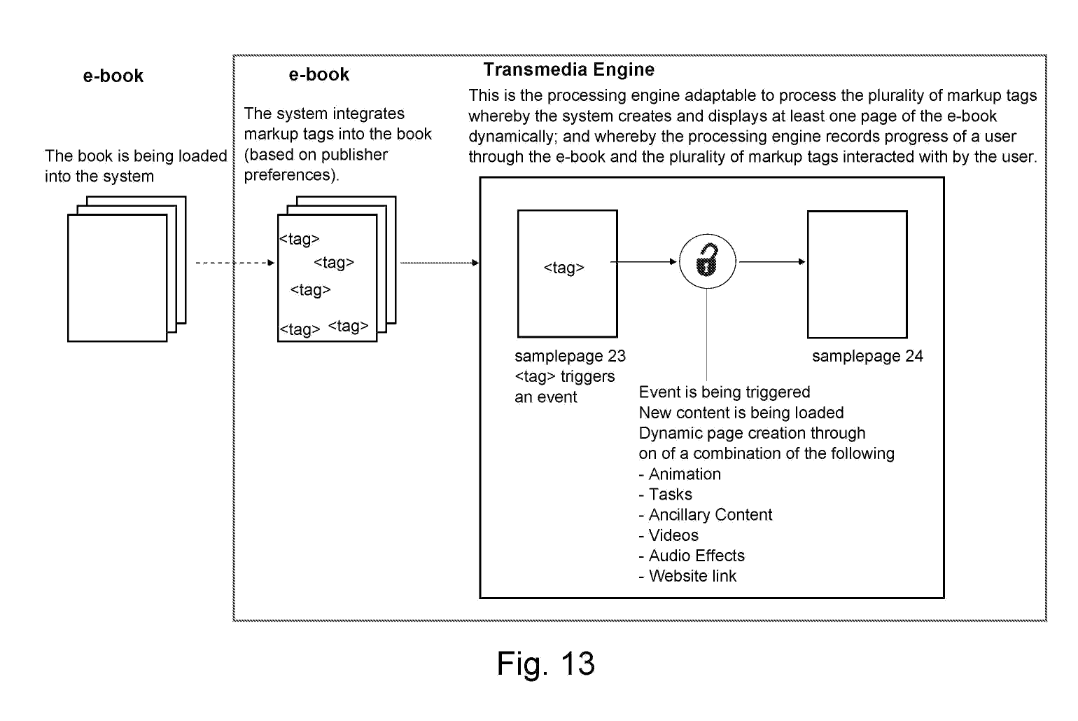

FIG. 13 shows a diagrammatic representation of the steps performed by an exemplary embodiment of the invention. Starting on the left side of the diagram, the system first loads an e-book, and integrates into the e-book a plurality of markup tags (based on published preferences). Subsequent to loading the e-book and the plurality of markup tags the system creates and displays at least one page of the e-book dynamically, and records the progress of a user through the e-book and the user's interactions with the plurality of markup tags. As seen in the middle of the diagram, when a user triggers an event by interacting with content with which a triggering event markup tag is associated the system triggers the event. The event may be the unlocking of previously locked content, an animation, a task, ancillary content, a video, an audio effect, a website link, a page effect, or any combination thereof. After the triggering event is complete the user will be returned to the e-book.

The preferred embodiment includes a method for enhancing the reading experience of the e-book utilizing the system 10. In the method, the application program is installed on an electronic device capable of displaying e-books. The user launches the application program in the electronic device and the screen 14 displaying the cover page of the corresponding e-book may be displayed. The main menu 16 for selecting the at least one feature 26 and the at least one reading mode 18 may be displayed. The at least one page is compiled at the run-time and the processing engine reads the plurality of markup tags to display the information stored in the e-book.

The plurality of markup tags indicates among other things a certain task that the user may be prompted to perform. The processing engine examines the markup tags and displays a relevant page of the e-book with the appropriate additional content. A tag may only indicate a certain point in a section of the e-book, for instance a story. The processing engine records the information about the user, such as which tasks the user has performed and whether or not the user chose to view ancillary content such as media content. This information may be used to unlock additional content in the e-book, or to block information that the user is not yet meant to see. For example, when the processing engine detects that the user has reached a point in the e-book that contains a specific tag, a certain number of tags or a certain combination of tags, additional content may be unlocked. If the content is locked, it will not be triggered or available to the reader. It is not necessary that all additional content be locked when the user first launches the e-book. Some content may be locked when the user first purchases the e-book, but the user may unlock the content by reaching the tags within the e-book or by completing other tasks tracked by the processing engine. In this way, the experience of the e-book may be enhanced with an additional layer of content. The system 10 may utilize a server to track the user's progress and the server may be local to the device or remote, i.e. accessed via the Internet.

In one embodiment of the present invention, when the user indicates that he wishes to view the next page of the e-book, the processing engine determines the words to be displayed and, based on the markup tags associated with those words, takes appropriate actions such as displaying animated effects or unlocking additional content. Though the words of the story are static, each page is created dynamically. When the processing engine creates a page, it checks the text to be displayed on that page for the markup tags and prepares the appropriate page. For example, if the tag indicates that a word links to an ancillary content, then that fact may be made known to the user by for instance the system displaying the tag text in a different color or font. The processing engine also creates an appropriate data ink so that if the user clicks or touches that text, the ancillary content is loaded. The processing engine records the fact that the user chose to view the ancillary content, or chose not to view the ancillary content.

The present invention also provides a means for adding an additional layer of content to a pre-existing e-book. Using this method, a publisher of an existing e-book may easily add markup tags to an existing story, bringing new life to the story and creating an interactive experience for the user. The words of the story are not necessarily altered at all, and custom pages may not necessarily be created. However, the publisher may add tags to the text in order to enhance the story. For example, the publisher might add a “shatter” tag to the section of the story in which a window is shattered. When the processing engine compiles the page of the story that contains the shatter tag, an animation may be triggered and presented to the user. The animation may show the entire page, including all words currently displayed, shattering like the window in order to enhance the story. The shattering animation may be shown by the processing engine on whatever page the tag is encountered, regardless of the font-size or screen size.

As will be readily appreciated, this system enables a publisher to quickly, easily, and cheaply enhance a user's experience of an e-book. The process of adding markup tags to an existing e-book allows a publisher to add additional content and interactive features to an e-book without expensive and time consuming processes, and without reformatting the entire e-book.

In reading mode 1 20, the user reads the e-book without any of the enhancements provided by the present invention. In another embodiment of the present invention, markup tags indicate that a certain task may be performed at a certain place in the e-book. When the processing engine creates the page that contains the markup tags for presentation to the user, the processing engine will display the task. For example, a task may prompt the user to answer a question, or select some text or animated object. The user may choose to complete the task, or the user may choose to ignore the task. The engine will record the fact that the task was presented to the user and will record whether or not the user performed the task. The processing engine may unlock content based on the user's action and the information stored in the e-book. For example, in the case of a mystery book, the task may be a question about a clue uncovered by the reader in the story. The question might ask the user to make a conclusion based on that clue, such as the identity of who committed the murder in the story. If the user answers correctly, a video of the murder may be made available to the user. If the user answers incorrectly, the user may be given a hint or sent back to a previous stage of the e-book where content previously displayed is presented again with more detail or highlighting of certain text. Additional features limiting the number or frequency of guesses may be implemented. For instance, in one embodiment the user is only provided the question as to the identity of the murderer once per day.

The markup tags may further indicate that certain text is a hint to a task that will be presented to the user. The processing engine may highlight that text when it is presented to the user, or may choose to highlight that text only the second time it is presented to the user, such as is described in the preceding paragraph. In one embodiment of the present invention, a computing means interprets the tags and takes an appropriate action based on the tags, such as displaying the animation, playing the sound effect, unlocking additional content, or presenting the task to the user.

In another embodiment of the present invention, the titles of certain ancillary content may be shown to the user in the table of contents, but not made available. As the user progresses through the story, the ancillary content may be unlocked when the user reaches the appropriate triggering tag. For example, the table of contents may contain links to biographies for several characters, but those links are not live when the user first launches the e-book. The markup tags are added to the story to indicate when a character is first introduced to the user. When the processing engine determines that the user has encountered the appropriate markup tag, a biography associated with that character is unlocked and the link on the dashboard 66 becomes live so the user may click on it and read the character's biography. The user may be notified that he or she has unlocked ancillary content when the triggering tag is reached.

The user of the e-book may also be given the opportunity to perform a task related to a particular passage of the e-book. Upon completion of the task, an animation, video, or sound effect is loaded on the screen providing additional content related to the passage of the e-book that the user is currently reading. The user may continue reading the e-book regardless of whether the user completes the task or not. If the user does not complete the task, the user's experience may be the same as a user who has purchased the e-book without utilizing the features of the system 10. However, if the task is completed, the user experience will be enhanced by the addition of ancillary content or an alteration of the presentation of the existing content.

The foregoing description of the preferred embodiment of the present invention has been presented for the purpose of illustration and description. It is not intended to be exhaustive or to limit the invention to the precise form disclosed. Many modifications and variations are possible in light of the above teachings. It is intended that the scope of the present invention not be limited by this detailed description, but by the claims and the equivalents to the claims appended hereto.

1. A system for displaying an e-book, the system comprising:
a. an electronic device comprising a display responsive to commands by a user;
b. a plurality of markup tags associated with information stored in said e-book, wherein some of said information is initially locked;
c. an application program configured for use in said electronic device, said application program comprising a processing engine adapted to process said information and said plurality of markup tags to create and display at least one page of said e-book dynamically; and
d. wherein said processing engine records progress of a user through said e-book and said plurality of markup tags interacted with by said user.

2. The system of claim 1 wherein said at least one page of said e-book comprises a plurality of words having a font size, and wherein said font size is customizable.

3. The system of claim 1 wherein said plurality of markup tags indicate at least one of either a triggering event or a command to unlock said locked information.

4. The system of claim 3 wherein said display comprises a touch sensitive screen that is used to obtain touch data from a user in response to touch events by the user, and wherein said triggering event is initiated in response to a touch event associated with content with which a tag is associated that denotes said triggering event.

5. The system of claim 3 wherein said triggering event is one of either an animation, ancillary content, a video, a website link, an audio effect, or a command to unlock said locked information.

6. The system of claim 5 wherein said display comprises a touch sensitive screen that is used to obtain touch data from a user in response to touch events by the user, and wherein said triggering event is initiated in response to a touch event associated with content with which a tag is associated that denotes said triggering event.

7. The system of claim 6 wherein said at least one page of said e-book comprises a plurality of words having a font size, and wherein said font size is customizable.

8. A system for displaying an e-book adapted for use in an electronic device, the system comprising:
a. a display upon which is displayed at least one page of said e-book, said display responsive to commands by a user;
b. locked and unlocked content and a plurality of tags associated therewith, wherein said plurality of tags denote at least one of a triggering event or whether the content associated with said tag is locked or unlocked;
c. a processing engine which processes said plurality of tags, wherein when one of said plurality of tags denoting a triggering event is processed the system executes said triggering event; and
d. wherein said triggering event is one of either an animation, ancillary content, a video, a website link, an audio effect, or a command to transform locked content to unlocked content.

9. The system of claim 8 wherein said display comprises a touch sensitive screen that is used to obtain touch data from a user in response to touch events by the user, and wherein said triggering event is initiated in response to a touch event associated with content with which a tag is associated that denotes said triggering event.

10. The system of claim 8 wherein said at least one page of said e-book comprises a plurality of words having a font size, and wherein said font size is customizable.

11. The system of claim 8 wherein said processing engine processes said content and said plurality of tags to dynamically create and display said at least one page of said e-book.

12. The system of claim 11 wherein said display comprises a touch sensitive screen that is used to obtain touch data from a user in response to touch events by the user, and wherein said triggering event is initiated in response to a touch event associated with content with which a tag is associated that denotes said triggering event.

13. The system of claim 11 wherein said at least one page of said e-book comprises a plurality of words having a font size, and wherein said font size is customizable.

14. A method for enhancing a user's experience of an e-book, the method comprising the steps of:
a. providing an electronic document comprising content and tags associated with specific portions of said content, and a display upon which is displayed at least one page of said e-book, said display responsive to commands by a user;
b. wherein said tags denote at least one of either a triggering event or whether said specific portions of said content are locked or unlocked;
c. processing said content and said tags with a processing engine to generate said at least one page of said e-book; and
c. executing a triggering event when said processing engine processes a tag which denotes said triggering event, wherein said triggering event is one of either an animation, ancillary content, a video, a website link, an audio effect, or a command to transform said specific portion of said content.

15. The method of claim 14 further comprising the step of displaying a menu on said display screen, said menu comprising an option to change at least one of either a font size or a background color.

16. The method of claim 14 wherein said processing engine generates said at least one page at run time.

17. The method of claim 14 wherein said specific portion of said content is transformed from locked content to unlocked content.

18. The method of claim 17 wherein said processing engine generates said at least one page at run time.

19. The method of claim 14 further comprising the step of obtaining touch data from a user in response to touch events by the user on said display, and executing said triggering event when said touch event is associated with said specific portion of said content with which a triggering event is associated.

20. The method of claim 19 wherein said processing engine generates said at least one page at run time.
